(19) United States
(12) Patent Application Publication
(10) Pub. No.: US 2013/0101956 A1
(43) Pub. Date: Apr. 25, 2013

(54) Endodontic Instrument

(71) Applicant: Steven Larsen, North Logan, UT (US)

(72) Inventor: Steven Larsen, North Logan, UT (US)

(21) Appl. No.: 13/444,367

(22) Filed: Apr. 11, 2012

Related U.S. Application Data
(63) Continuation-in-part of application No. 10/690,421, filed on Oct. 20, 2003.

(51) Int. Cl. A61C 5/02

(52) U.S. Cl. CPC A61C 5/023
USPC 433/102

(57) ABSTRACT

The invention is an endodontic instrument which comprises, among other features: a handle having an elongated base with a threaded projection having a recessed distal surface capable of cupping a first terminus portion of an elongated plastic grip attached to an endodontic file; and a cap containing a channel extending through the cap with the channel being threaded for mating with the projection of the elongated base of said endodontic instrument handle, said cap possessing a side and containing an aperture through which an endodontic file can project, the diameter of the aperture being selected to be larger than the diameter of the endodontic file but smaller than the diameter of a plastic grip attached to the endodontic file, said cap further having a recessed interior surface capable of cupping a second terminus portion of an elongated plastic grip attached to an endodontic file.

### CROSS-REFERENCE TO RELATED APPLICATIONS

This application is a continuation in part of, and claims priority to, U.S. application Ser. No. 10/690,421, Publication No. US 2005-0084818 A1.

### TECHNICAL FIELD OF THE INVENTION

This invention relates to endodontic tools, especially a holder for an endodontic file.

### BACKGROUND OF THE INVENTION

In order to preserve a tooth that has diseased pulp material therein, it is necessary to prevent bacterial proliferation within the pulp canal of the tooth by removing the diseased or necrotic pulp material from the pulp cavity or root canal. After pulp material has been removed or extirpated from a tooth, the pulp cavity or root canal is typically filled or oburated with an inert material in order to prevent future infection of the tooth root. This procedure is referred to as root canal therapy.

During root canal therapy, it is essential that the entire root canal be cleaned and filled to eliminate all organic matter contained within the root canal. The typical method for root canal therapy is to open the tooth to the pulp chamber and then find each canal orifice opening and work a small endodontic file down to the root end of the tooth. This small file is worked up and down the canal to create a smooth path, clear pulp tissue debris, and start the canal preparation. This initial root preparation is critical to the success of the treatment. This initial preparation of the canal serves as a “glide path” or “pilot hole” for all the other manual or mechanical instruments with files or bits to enlarge this initial preparation of the root canal to a finish prepared shape.

The root canal system of a human tooth is often narrow, curved, and calcified. It can be extremely difficult to negotiate or clean. Posterior teeth, molars, and premolars can be even more difficult to treat because of the limited room or space in which to operate. The mechanical manipulation the endodontic files in cleaning out the canals in this small limited space can become tedious in preparing the proper “glide path” preparation.

Conventional dental instruments used during root canal therapy—such as various endodontic file instruments—generally include a thin, flexible, metal shaft or file with an abrasive surface or sharp edges, which enables efficient cleaning of the root canal. A small, elongated plastic grip handle or hub end is attached at one end of the file instrument and is conventionally adapted for gripping by the dentist with the thumb and index finger in a “two-finger” grip.

The small, elongated plastic grip of these files mostly have a common dimensional hour glass shape. Most dental manufactures have maintained the uniformity of these grips which are standard in clinical endodontic instruments.

The “two-finger” grip is mostly unique in dentistry for holding the endodontic file instrument. Almost all other working operative instruments in dentistry are held by a long handle in a full hand pencil grip or “pen-grasp-grip.” For example the dental mirror, dental explorer, scaler, periodontal probe, material placing instrument, and others all have long handles which the dentist uses in the “pen-grasp-grip” or pencil grip.

Of additional interest is the fact that all of these dental tools mentioned have built into their design a “dental angle”. This “dental angle” allows better access and visibility to the tooth surfaces being examined, when cavities are filled, or teeth are being cleaned. For example: the dental mirror is angled for better access to see the various surfaces of the teeth, especially the posterior teeth. The dental explorer, scaler, periodontal probe, and material placing instrument all use the “dental angle” for the same reason, better access and better visibility in operating the instrument.

On the other hand, the conventional “two-finger” grip on the small handle of an endodontic file does not lend itself to having a built-in “dental angle.” The file is held by the dentist in a vertical straight line position to operate. With the files measuring 25 to 35 millimeters in length, the placement of these files into the canal and the working of these files with the conventional “two-finger” grip can be tedious and time consuming. Accessing molar and premolar teeth can be difficult most cases.

Visibility to see the canal orifice so as to place the file is also very difficult when holding the file in the conventional file grip. The dentist's fingers holding the file, obstruct the view into the pulp chamber and the small orifice of the canal into which the file is to be placed.

The problems with the conventional manner of gripping an endodontic file in root canal therapy, especially in molars and premolars are numerous. With the limited space to do the root canal procedure, the “two-finger” endodontic file grip hinders the visibility to find the canals. The dentist's fingers holding the file obstruct the field of view to the canals. It is difficult access and treat these cases with the conventional grip on the file.

Molar and premolar teeth usually require multiple filing motions even a hundred or more cycles of motion in preparing the initial “glide path.” The filing manipulation in molar and premolar teeth can be very tedious and tiring to the dentist and the patient. The dentist fingers have to be positioned over the tooth to work the file in the canal. Many times in treating molars and premolar it requires the patient to stretch open as wide as possible for quite some time.

Accordingly, there is a need for an improved endodontic device that overcomes or avoids the above problems, among many others. Holding the standard endodontic file in a pen-grasp-grip or pencil grip gives the dentist secure control of the file. An unsecured or slippery file grip can lead to error and injury.

### BRIEF SUMMARY OF THE INVENTION

Therefore, an innovative endodontic instrument is provided which comprises, among other features: a handle having an elongated base with a threaded projection at a first end, the projection having a recessed distal surface capable of cupping a first terminus portion of an elongated plastic grip attached to an endodontic file; and a cap containing a channel extending through a first end of said cap with a first portion of the channel being threaded for mating with the projection of the elongated base of said endodontic instrument handle, said cap possessing a side, and said cap also having a second end containing an aperture through which an endodontic file can project, the diameter of the aperture being selected to be larger than the diameter of the endodontic file but smaller than the diameter of a plastic grip attached to the endodontic file, said cap further having a recessed interior surface capable of cupping a second terminus portion of an elongated plastic grip attached to an endodontic file. This instrument helps prevent the problems noted above, including awkward access angles and unsecured or slippery file grip that can lead to loss of control of the endodontic file during the root canal procedure and the possibility of swallowing or inhalation of the uncontrolled endodontic file leading to serious injury.

### BRIEF DESCRIPTION OF THE SEVERAL VIEWS OF THE DRAWINGS

FIG. 1 is a side view of an endodontic file in one embodiment of the invention.

FIG. 2 is a side view of the handle and cap in one embodiment of the invention.

FIG. 3 is a cross-section, exploded view of the handle, endodontic file, and cap in one embodiment of the invention.

FIG. 4 is a cross-section of the handle, endodontic file, and cap in one embodiment of the invention.

FIG. 5 is a perspective view of one embodiment of the invention.

### DETAILED DESCRIPTION OF THE INVENTION

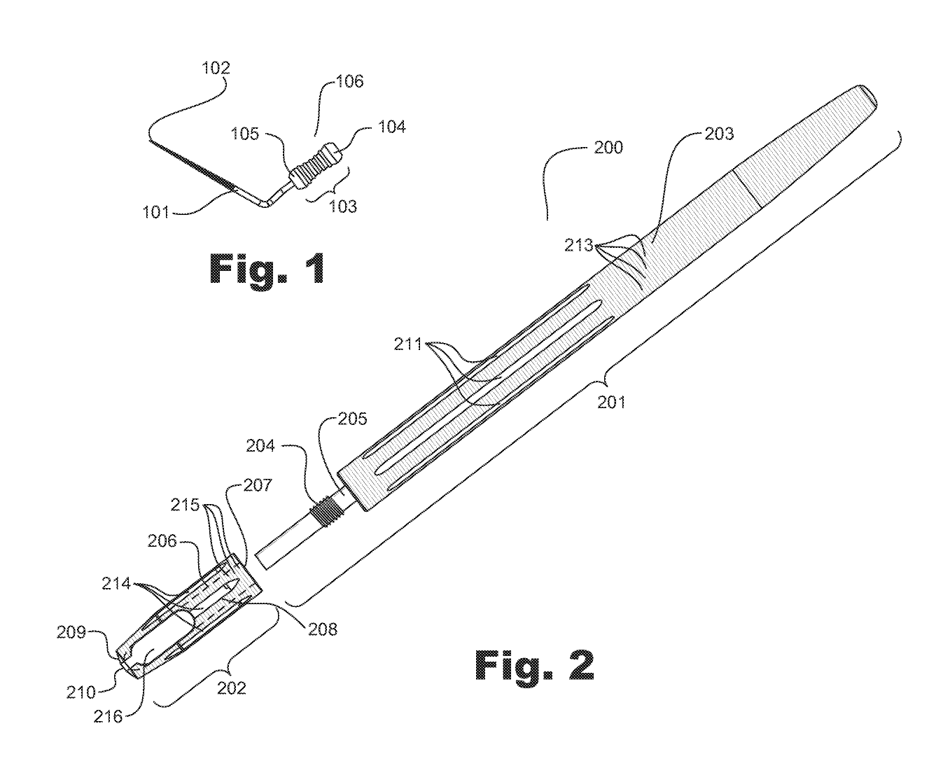

Referring now to FIG. 1, an endodontic file 101 is a small, tapered, fluted wire with a tip 102 and to which may be attached an elongated plastic grip 103 with a first terminus portion 104 and a second terminus portion 105. The file 101 is used in preparing and cleaning the root canal of a tooth. In various embodiments, the first and second terminus portions 104, 105 of the elongated plastic grip 103 may have distally curving surfaces and/or partially rounded ends.

Referring now to FIG. 2, the present holder 200 has a handle 201 and a cap 202.

The handle 201 employs an elongated base 203 having a threaded projection 204 at a first end 205. In various embodiments, the handle 201 has a plurality of longitudinally oriented recessed grooves 211 adjacent to the first end 205 of the elongated base 203 for increasing the handle's grip surface area and for providing rotational control of the instrument when in use. In still other embodiments, the handle has a plurality of transversely oriented recessed grooves 213 on the elongated base 203 for increasing the handle's grip surface area and for reducing longitudinal slippage when in use. Such transversely oriented recessed groves 213 may be shallower and greater in number than the longitudinally oriented recessed grooves 211.

Preferably, the maximum outer diameter of the cap 202 is substantially the same as the maximum outer diameter of the elongated base 203.

The cap 202 contains a channel 206 extending through a first end 207 of the cap The first portion 208 of the channel 206 is threaded (not shown) for mating with the projection 204 of the elongated base 203. The second end 209 of the cap 202 contains an aperture 210 through which an endodontic file 101 can project. In various embodiments, the cap 202 also has a plurality of longitudinally oriented recessed grooves 214 adjacent to the first end 207 of the cap 202 for increasing the cap's grip surface area and for providing rotational control when in use. In still other embodiments, the cap has a plurality of transversely oriented recessed grooves 215 for increasing the cap's grip surface area and for reducing longitudinal slippage when in use. Such transversely oriented recessed groves 215 may be shallower and greater in number than the longitudinally oriented recessed grooves 214.

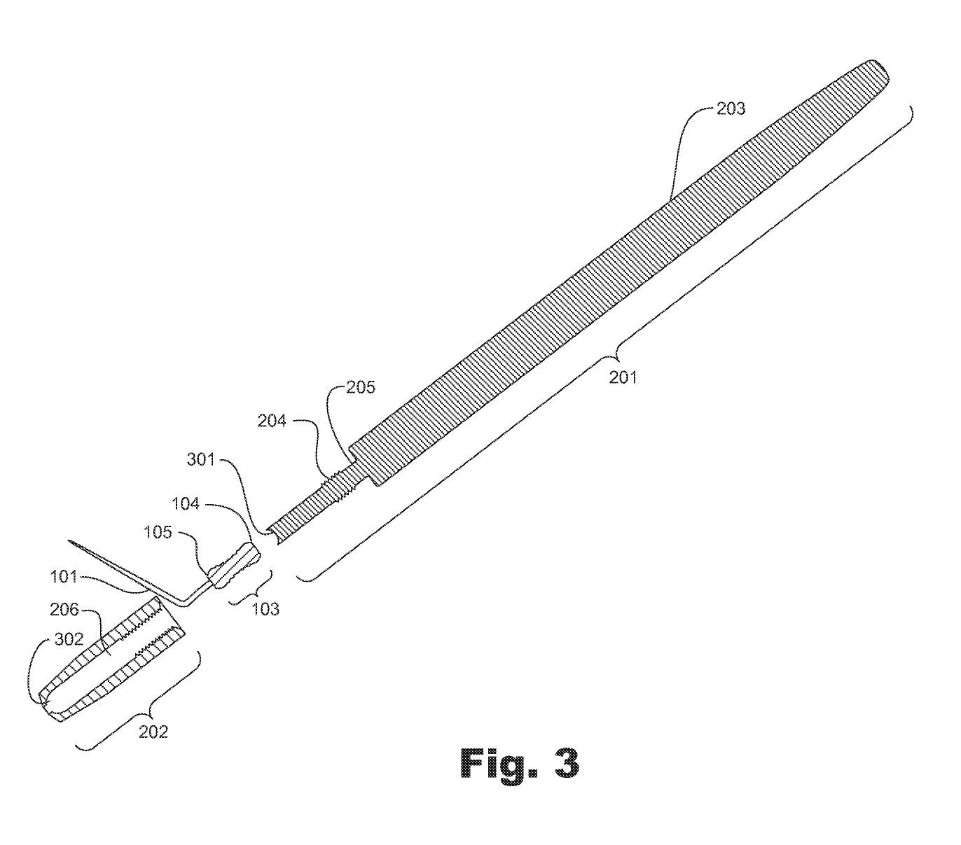

Referring now to the cross-section of FIG. 3, in various embodiments the threaded projection 204 and cap 202 have surfaces uniquely tailored, partially, and/or substantially complimentary to the distally curving surfaces and/or partially rounded ends of the elongated plastic grip 103 attached to an endodontic file 101. Specifically, the projection 205 of the elongated base 204 may have a recessed distal surface 301 capable of cupping a first terminus portion 104 of an elongated plastic grip 103 attached to an endodontic file 101. Likewise, the cap 202 may have a recessed interior surface 302, located within the channel 206, and capable of cupping a second terminus portion 105 of an elongated plastic grip 103 attached to an endodontic file 101.

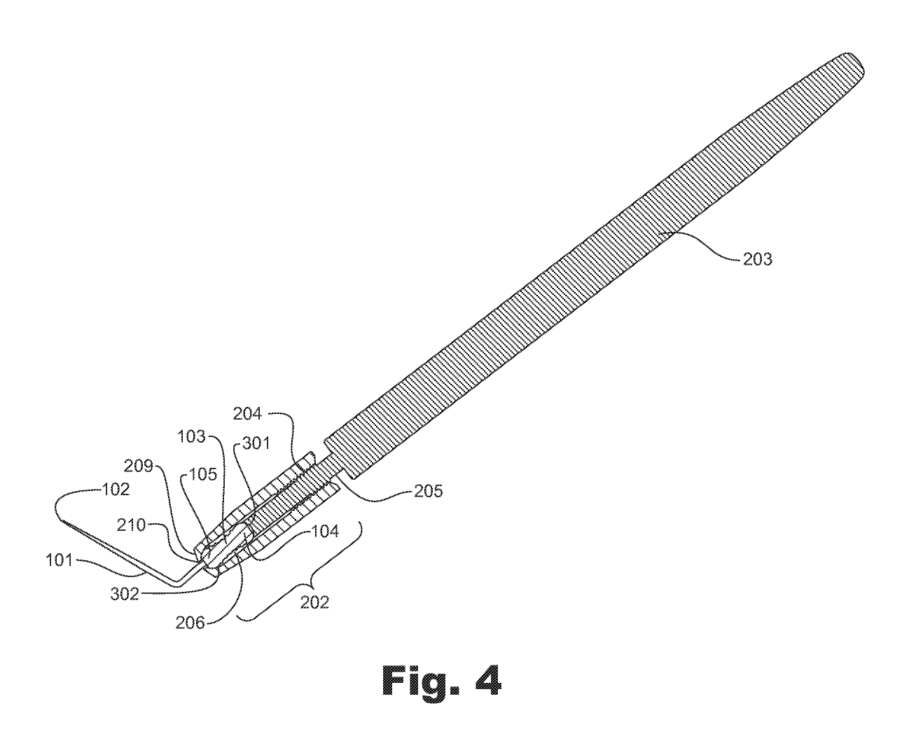

Referring now to the cross-section of FIG. 4, in use, an endodontic file 101 is placed so that it extends through the aperture 210 with the elongated plastic grip 103 that is attached to the endodontic file 101 (at an end 106 opposite to the tip 102) being in the channel 206. (The diameter of the aperture 210 is selected to be larger than the diameter of the endodontic file 101 but smaller than the diameter of the elongated plastic grip 103.) The cap 202 is then screwed closer to the first end 205 of the elongated base 203 until the elongated plastic grip 103 is securely retained in the channel 206 between the second end 209 of the cap 202 and the projection 204, as a result of the recessed distal surface of the projection 301 cupping the first terminus portion 104 of the plastic grip 103 and the recessed interior surface 302 of the cap 202 cupping the second terminus portion 105 of the plastic grip 103 through a compression fit achieved from the mating of the elongated base 203 and cap 202.

As a result of this configuration, including the surfaces 301 and 302 of the threaded projection 204 and cap 202 being uniquely tailored, partially, and/or substantially complimentary to the distally curving surfaces and/or partially rounded ends of the elongated plastic grip attached to an endodontic file, the elongated plastic grip 103 is securely maintained by maximizing surface area contact between parts during the mating of the elongated base 203 and cap 202 and consequent compression fit. Indeed, when so securely maintained, the tip of the endodontic file 102 is not capable of being variably positioned within the instrument along the Y axis due to the compression fit.

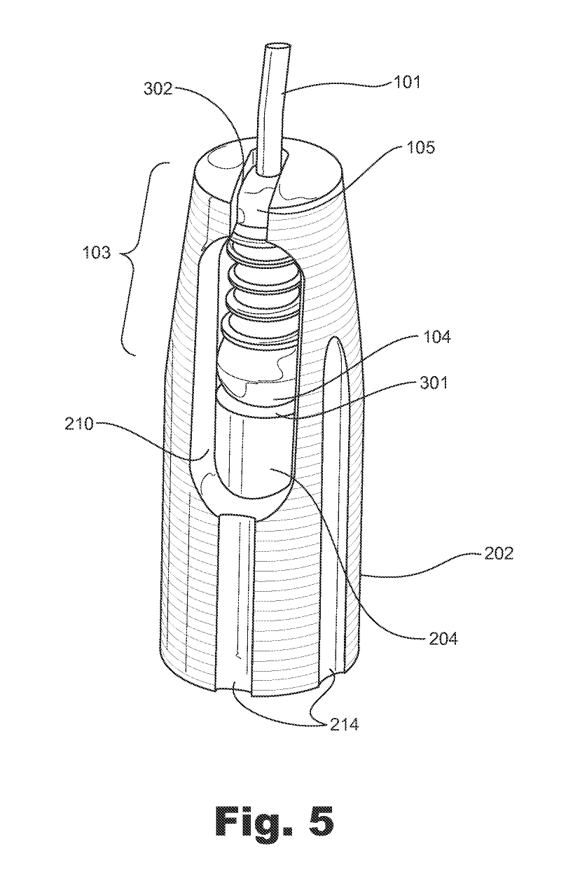

Referring now to FIG. 5, a closer perspective view of the elongated plastic grip 103 within the channel illustrates the manner of fitting and structure within one embodiment of the invention.

In order to facilitate the work of an endodontist, an option to the present invention is, as portrayed in FIG. 4, an endodontic file 101 that initially moves away from the centerline of the endodontic file 101 in a first direction shown by the arrow A and then curves back toward and crosses the centerline as the tip 102 of the endodontic file 101 is approached but does not then again cross the centerline.

Referring back to FIG. 2, in order to accommodate such a bent endodontic file 101, the aperture 210 is extended to the side 216 of the cap 202 and, on such side 216, enlarged to dimensions sufficient to permit the introduction into the channel 206 of the elongated plastic grip 103.

The instrument aids the dentist by changing the thumb-and-finger grip to a secure pencil-type grip, which is more suitable for manipulating the endodontic file 101. And the bent endodontic file 101 permits the dentist to place his or her hand in a more convenient location.

As used herein, the term “substantially” indicates that one skilled in the art would consider the value modified by such terms to be within acceptable limits for the stated value. Also as used herein the term “preferable” or “preferably” means that a specified element or technique is more acceptable than another but not that such specified element or technique is a necessity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An endodontic instrument, which comprises:
a handle having an elongated base with a threaded projection at a first end, the projection having a recessed distal surface capable of cupping a first terminus portion of an elongated plastic grip attached to an endodontic file; and
a cap containing a channel extending through a first end of said cap with a first portion of the channel being threaded for mating with the projection of the elongated base of said endodontic instrument handle, said cap possessing a side, and said cap also having a second end containing an aperture through which an endodontic file can project, the diameter of the aperture being selected to be larger than the diameter of the endodontic file but smaller than the diameter of a plastic grip attached to the endodontic file, said cap further having a recessed interior surface capable of cupping a second terminus portion of an elongated plastic grip attached to an endodontic file.

2. The endodontic instrument as recited in claim 1, wherein:
the elongated base has a maximum outer diameter;
said cap has a maximum outer diameter; and
the maximum outer diameter of said cap is substantially the same as the maximum outer diameter of the elongated base.

3. The endodontic instrument as recited in claim 1, further comprising:
an endodontic file with a tip and also with an elongated plastic grip having first and second terminus portions, said grip attached to said endodontic file at an end opposite to the tip, said endodontic file extending through the aperture in the second end of said cap and the attached plastic grip being contained within the channel of said cap so that the recessed distal surface of the projection cups the first terminus portion of the plastic grip and the recessed interior surface of the cap cups the second terminus portion of the plastic grip through a compression fit achieved from the threaded mating of the elongated base and cap.

4. The endodontic instrument as recited in claim 3, wherein:
the elongated base has a maximum outer diameter;
said cap has a maximum outer diameter; and
the maximum outer diameter of said cap is substantially the same as the maximum outer diameter of the elongated base.

5. The endodontic instrument of claim 3, wherein the first and second terminus portions of the elongated plastic grip have distally curving surfaces.

6. The endodontic instrument of claim 3, wherein the first and second terminus portions of the elongated plastic grip have partially rounded ends.

7. The endodontic instrument of claim 1, wherein the tip of the endodontic file is not capable of being variably positioned within the instrument along the Y axis through a compression fit.

8. The endodontic instrument as recited in claim 1, wherein:
the aperture in the second end of said cap extends to the side of said cap and, on such side, is enlarged to dimensions sufficient to permit the introduction in the channel of the plastic grip attached to the endodontic file.

9. The endodontic instrument as recited in claim 8, wherein:
the elongated base has a maximum outer diameter;
said cap has a maximum outer diameter; and
the maximum outer diameter of said cap is substantially the same as the maximum outer diameter of the elongated base.

10. The endodontic instrument as recited in claim 1, the handle further having a plurality of longitudinally oriented recessed grooves adjacent to the first end of the elongated base for increasing the handle's surface area.

11. The endodontic instrument as recited in claim 1, the cap further having a plurality of longitudinally oriented recessed grooves for increasing the cap's surface area.

12. The endodontic instrument as recited in claim 10, the handle further having a plurality of transversely oriented recessed grooves on the elongated base for increasing the handle's surface area, said transversely oriented grooves being shallower and greater in number than the longitudinally oriented recessed grooves.

13. An endodontic instrument, which comprises:
a handle having an elongated base with a threaded projection at a first end and a maximum outer diameter, the projection further having a recessed distal surface capable of cupping a first terminus portion of a plastic grip attached to an endodontic file;
a cap having a maximum outer diameter substantially the same as the maximum outer diameter of the elongated base and containing a channel extending through a first end of said cap with a first portion of the channel being threaded for mating with the projection of the elongated base of said endodontic instrument handle, said cap possessing a side, and said cap also having a second end containing an aperture through which an endodontic file can project, the diameter of the aperture being selected to be larger than the diameter of the endodontic file but smaller than the diameter of an elongated plastic handle attached to an endodontic file, the aperture extending to the side of said cap and, on such side, is enlarged to dimensions sufficient to permit the introduction in the channel of an elongated plastic grip attached to an endodontic file, said cap further having a recessed interior surface capable of cupping a first terminus portion of an elongated plastic grip attached to an endodontic file; and
an endodontic file with a tip and also with an elongated plastic grip having first and second terminus portions, said grip attached to said endodontic file at an end opposite to the tip, said endodontic file extending through the aperture in the second end of said cap and the attached plastic grip being contained within the channel of said cap so that the recessed distal surface of the projection cups the first terminus portion of the elongated plastic grip and the recessed interior surface of the cap cups the second terminus portion of the elongated plastic grip through a compression fit achieved from the threaded mating of the elongated base and cap.

14. The endodontic instrument as recited in claim 13, the handle further having a plurality of longitudinally oriented recessed grooves adjacent to the first end of the elongated base for increasing the handle's grip surface area and for providing rotational control of the instrument when in use.

15. The endodontic instrument as recited in claim 13, the cap further having a plurality of longitudinally oriented recessed grooves for increasing the cap's grip surface area and for providing rotational control of the instrument when in use.

16. The endodontic instrument as recited in claim 13, the handle further having a plurality of transversely oriented recessed grooves on the elongated base for increasing the handle's grip surface area and for reducing longitudinal slippage, said transversely oriented grooves being shallower and greater in number than the longitudinally oriented recessed grooves.

17. The endodontic instrument of claim 13, wherein the tip of the endodontic file is not capable of being variably positioned within the instrument along the Y axis through a compression fit.

18. The endodontic instrument of claim 13 wherein the first and second terminus portions of the elongated plastic grip have distally curving surfaces.

19. The endodontic instrument of claim 13 wherein the first and second terminus portions of the elongated grip have partially rounded ends.

20. An endodontic instrument, which comprises:
a handle having an elongated base with a threaded projection at a first end and a maximum outer diameter, the handle further having a plurality of longitudinally oriented recessed grooves adjacent to the first end of the elongated base for increasing grip surface area on the instrument, the handle further having a plurality of transversely oriented recessed grooves on the elongated base for increasing grip surface on the elongated base, said transversely oriented grooves being shallower and greater in number than the longitudinally oriented recessed grooves, and the projection having a recessed distal surface capable of cupping a first terminus portion of a plastic grip attached to an endodontic file;
a cap having a maximum outer diameter substantially the same as the maximum outer diameter of the elongated base and containing a channel extending through a first end of said cap with a first portion of the channel being threaded for mating with the projection of the elongated base of said endodontic instrument handle, said cap possessing a side, and said cap also having a second end containing an aperture through which an endodontic file can project, the diameter of the aperture being selected to be larger than the diameter of the endodontic file but smaller than the diameter of an elongated plastic grip attached to the endodontic file, the aperture extending to the side of said cap and, on such side, is enlarged to dimensions sufficient to permit the introduction in the channel of an elongated plastic grip attached to an endodontic file, said cap further having a recessed interior surface capable of cupping a second terminus portion of an elongated plastic grip attached to an endodontic file, said cap further having a plurality of longitudinally oriented recessed grooves for increasing the cap's grip surface area and for providing rotational control of the instrument when in use, said cap further having a plurality of transversely oriented recess grooves for increasing the caps grip surface area and for reducing longitudinal slippage when in use, said transversely oriented grooves being shallower and greater in number than the longitudinally oriented recessed grooves; and
an endodontic file with a tip and also with an elongated plastic grip having first and second terminus portions, said grip attached to said endodontic file at an end opposite to the tip, said endodontic file extending through the aperture in the second end of said cap and the attached plastic grip being contained within the channel of said cap so that the recessed distal surface of the projection cups the first terminus portion of the plastic grip and the recessed interior surface of the cap cups the second terminus portion of the plastic grip through a compression fit achieved from the threaded mating of the elongated base and cap.

21. The endodontic instrument of claim 20, wherein the tip of the endodontic file is not capable of being variably positioned within the instrument along the Y axis through a compression fit.

22. The endodontic instrument of claim 20 wherein the first and second terminus portions of the elongated plastic grip have distally curving surfaces.

23. The endodontic instrument of claim 20 wherein the first and second terminus portions of the elongated grip have partially rounded ends.
